(19) United States
(12) Patent Application Publication
(10) Pub. No.: US 2018/0290320 A1
(43) Pub. Date: Oct. 11, 2018

(54) SHAVING RAZOR

(71) Applicant: Zachary R. Wertz, South Lebanon, OH (US)

(72) Inventor: Zachary R. Wertz, South Lebanon, OH (US)

(21) Appl. No.: 16/003,725

(22) Filed: Jun. 8, 2018

Related U.S. Application Data
(63) Continuation of application No. 14/832,298, filed on Aug. 21, 2015.
Application No. 14/832,298 is a continuation-in-part of application No. PCT/US14/17988, filed on Feb. 24, 2014.
(60) Provisional application No. 61/768,357, filed on Feb. 22, 2013.

(51) Int. Cl. B26B 21/28; B26B 21/56; B26B 21/18; B26B 21/30

(52) U.S. Cl. CPC B26B 21/28; B26B 21/56; B26B 21/30; B26B 21/18

(57) ABSTRACT

A shaving device has a plane body including a slot defined in a contacting surface, having a blade resting surface shaped to receive a safety shaving blade and that opens to the slot to present a cutting edge of the shaving blade. The blade resting surface is distally angled at a shaving angle to the contacting surface and obliquely angled away from the handle. A blade door is pivotally attached to the plane body to form a retaining head having blade gripping surface that corresponds to the blade resting surface. A handle that is proximally attached to the retaining head. A locking mechanism engageably holds the blade door in a closed position that tensions the shaving blade between the blade resting surface and the blade gripping surface.

### CROSS-REFERENCE TO RELATED APPLICATIONS

This application is a continuation of the earlier filed continuation-in-part U.S. patent Ser. No. 14/832,298, filed Aug. 21, 2015, entitled “Shaving Razor”, which in turn claims the benefit of international (PCT) application PCT/US14/17988, filed Feb. 24, 2014, entitled “Shaving Razor”, which in turn claims the benefit of U.S. Provisional Application No. 61/768,357, filed Feb. 22, 2013, entitled “Female Adapter Double edge razor blade Safety Razor with floating/flexing head that adapts to changing forces and contours of face for shaving,” the disclosures of which are incorporated herein by reference in their entirety.

### BACKGROUND OF THE INVENTION

### 1. Field of the Invention

The field of art disclosed herein pertains to manual shaving razors and more particularly to shaving razors with replaceable blades.

### 2. Description of the Related Art

The original double edge safety razor development such as in U.S. Pat. No. 775,134 issued Nov. 15, 1904, afforded a method of achieving a close shave without the very real danger of serious injury that had previously attended the use of straight razors. Although the double edge safety razor has eliminated the possibility of serious injury, the very knowledge of this fact on the part of the user has tended to increase the number of minor abrasions and “nicks” occasioned by its use since one tends to shave with less care and precision than would be the case were serious injury possible. Additionally, such precision needed with a safety razor to avoid such abrasion and “nicks” requires a substantial learning curve that most users are not willing to take on especially given the current availability of modern razors with multiple blades and pivoting heads that can easily provide quick and “nick-proof” shave.

Such modern razors do indeed provide a virtually “nick-proof” shave thanks to their pivoting head and disposable cartridge design that has permanent fixed angled blades exposed within a gap at the base of the cartridge head as demonstrated in U.S. Pat. No. 5,813,293 issued Sep. 29, 1998. However, such modern shavers in comparison to double edge safety razors do not provide the low ongoing cost, irritation free, or baby butt smooth shave that a single expose bladed can provide such as with a straight razor or double edge safety razor. In addition, with each modern razor, a user has only one choice for an expensive non-recyclable blade cartridge to use, which is only provided by the manufacturer of the razor. However, with a single or edge safety razor a user has hundreds of choices of low cost recyclable razor blade manufacturers to choose from in order to customize which blade is best suited for their skin and hair follicles. Such a high volume double edge razor blade was first conceived by Gillette in U.S. Pat. No. 1,924,262 issued Aug. 29, 1933, and was thereafter standardized across the industry to use with all double edge safety razor manufacturers.

### SUMMARY OF THE INVENTION

In one aspect of the present innovation, a shaving device includes a plane body having a slot defined in a contacting surface and including a blade resting surface shaped to receive a half safety shaving blade and that opens to the slot to present a cutting edge of the shaving blade, the blade resting surface being distally angled at a shaving angle to the contacting surface and obliquely angled away from the handle. A blade door is pivotally attached to the plane body to form a retaining head having blade gripping surface that corresponds to the blade resting surface. A handle is proximally attached to the retaining head. A locking mechanism can engageably hold the blade door in a closed position that tensions the shaving blade between the blade resting surface and the blade gripping surface.

In one aspect of the present innovation, a shaving device includes a plane body having a slot defined in a contacting surface and having a blade resting surface shaped to receive a shaving blade and that opens to the slot to present a cutting edge of the shaving blade. The blade resting surface is distally angled at a shaving angle to the contacting surface and obliquely angled away from the handle. A handle is pivotally attached to the retaining head proximal to the cutting edge to move within a pivotal range to the plane body. A spring mechanism biases the plane body toward a minimum pivot angle.

These and other features are explained more fully in the embodiments illustrated below. It should be understood that in general the features of one embodiment also may be used in combination with features of another embodiment and that the embodiments are not intended to limit the scope of the invention.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 depicts an isometric, distal left view of a shaving razor, according to one or more embodiments;

FIG. 2 depicts an isometric, proximal left view of the shaving razor of FIG. 1, according to one or more embodiments

FIG. 3 illustrates an isometric left side view of the shaving razor of FIG. 1 with a replaceable shaving blade and replaceable contact surface removed, according to one or more embodiments;

FIG. 4 depicts an isometric, left side view of the shaving razor of FIG. 1 in an open position, according to one or more embodiments;

FIG. 5 illustrates a cross sectional left side diagram of the shaving razor of FIG. 1 in a closed position, according to one or more embodiments;

FIG. 6 illustrates a cross sectional left side diagram of the shaving razor of FIG. 1 in an open position, according to one or more embodiments;

FIG. 7 illustrates an isometric left side view of an alternative shaving head with a blade door in an open position and having a retaining screw for locking, according to one or more embodiments;

FIG. 8 illustrates an isometric right side view of the alternative shaving head of FIG. 7, according to one or more embodiments;

FIG. 9 illustrates a left side view of the alternative shaving head of FIG. 7, according to one or more embodiments;

FIG. 10 illustrates a left side view of the alternative shaving head of FIG. 7 with the blade door locked, according to one or more embodiments;

FIG. 11 illustrates a flow diagram of a method of making a shaving razor, according to one or more embodiments;

FIG. 12 illustrates a bottom view of an alternative shaving razor having a pivoting handle, according to one or more embodiments;

FIG. 13 illustrates a front isometric view of the alternative shaving razor of FIG. 12 with a closed blade door, according to one or more embodiments;

FIG. 14 illustrates a top view of the alternative shaving razor of FIG. 13, according to one or more embodiments;

FIG. 15 illustrates a rear isometric view of the alternative shaving razor of FIG. 12 with an open blade door, according to one or more embodiments;

FIG. 16 illustrates a left side view of the alternative shaving razor of FIG. 12 with internal connections depicted in phantom, according to one or more embodiments;

FIG. 17 illustrates a perspective view of another alternative shaving razor in an open position that receives a half safety razor, according to one or more embodiments;

FIG. 18 illustrates a diagram of a retaining head of the shaving razor of FIG. 17, according to one or more embodiments;

FIG. 19 illustrates a left side in elevation of the shaving razor of FIG. 17, according to one or more embodiments;

FIG. 20 illustrates a left front isometric view of the shaving razor of FIG. 17 with a retaining head in a closed, unlocked position, according to one or more embodiments;

FIG. 21 illustrates a left front isometric view of the shaving razor of FIG. 17 with a retaining head in a closed, locked position, according to one or more embodiments;

FIG. 22 illustrates a left side, cutaway view of the shaving razor of FIG. 17, according to one or more embodiments;

FIG. 23 illustrates a detail right side isometric view of the retaining head of the shaving razor of FIG. 17, according to one or more embodiments;

FIG. 24 illustrates an isometric bottom view of the shaving razor having longitudinal ribs on a contacting surface, according to one or more embodiments.

### DETAILED DESCRIPTION

The present innovation relates generally to safety razors used for the removal of hair on ones face and body manually using ones hands. In particular this involves a new concept in safety razor construction particularly involving single and double edge razor blades but not limited to only such razor blades. In the embodiments shown, the blades are double-edged blades, though the present invention applies to single-edged blades as well. This innovation involves a conventional handle and a clamping, retaining head connected to the handle that flexes and adapts independently to the users face and the forces placed upon the handle. In one embodiment, the razor of the present invention involves a conventional handle and a clamping, retaining head pivotally connected to the handle that flexes and adapts independently to the users face and the forces placed upon the handle. Such retaining head is provided with means for clamping an independent and removable razor blade therein with the blade positioned to extend through an opening in the base portion of the retaining head at a fixed angle relative to the users skin. In one embodiment, the razor of the present invention comprises a customizable handle. In another embodiment, in each alternative the user can swap out different handle materials and handle designs.

A manual razor according to the present disclosure allows consumers to have the advantages of an old fashioned single and single or edge safety razor without the safety dangers associated therewith, as well as the advantages of a modern razor without the expense, nonexistent blade choice, poor cutting quality, and irritation filled hassles to deal with. The manual razor of the present inventions comprises a handle portion, and a clamping retaining head portion. In one embodiment, the razor of the present invention comprises a handle portion, a pivot portion, and a clamping retaining head portion.

The top portion of the handle is attached to the retaining head via the pivot portion to allow the head of the manual razor to flex and maintain its position and angle in relation to being applied to the users skin irrespective of the pressure applied to the handle portion. The clamping retaining head portion has a blade compartment for holding commonly available, cheap, and recyclable razor blades at a constant fixed angle relative to the users' skin when in use. Unlike prior art, such a head in the present concept only exposes one side of the single or edge razor blade to the users skin at a time, thus allowing the preservation of the other side for when the current side becomes dull after repeated uses. Additionally, similar to a modern razor and unique to old fashioned safety razors and prior art, the current concept of the retaining head allows the consumer to not have to figure out which angle is the correct angle to hold the razor at since the razor blade is simply held at a fixed angle and exposed through an opening in the base portion of the retaining head. In one embodiment, the razor of the present invention comprises a retaining head adapted to use a variety of blade types. In another embodiment, in each alternative the retaining head is adapted to use one or more blade types selected form the group consisting of double edge safety razor blades, shavette razor blades and artist club razor blades.

The clamping retaining head portion can provide a tensioning system to prevent the razor blade from moving while in use and provide the proper fixed angle sought. Such a safety razor allows consumers lacking professional dexterity to put a razor blade against the skin at a constant fixed ideal angle via a flat bottom and pivoting neck for movement transverse to the path of movement that is insensitive not only to variations in the application of the handle pressure but also to other skin aberrations which tend to increase blade pressure. The pivoting neck permits a constant blade pressure to be exerted on the skin irrespective of the pressure, which is exerted on the handle to a certain degree. There are numerous alternatives to affix the disposable blade to the retaining head, and this patent application is not meant to limit itself to anyone design.

The blade compartment of the retaining head defines a cavity for holding the blade in a fixed position using tension when in use. However, such a cavity can consist of several alternatives to create the tension to hold the single or edge razor blade still that may include a flat or curving wall that the user uses to slide around a protruding element and lock the blade using tension from the arch, a screw to screw in the blade on a flat or curved surface and lock the blade, or various other alternatives not yet considered that will securely hold the blade so there is no movement when in use. In one embodiment, such a cavity can consist of several alternatives to create the tension to hold the single or edge razor blade still that may include a flat or curving wall that the user uses to slide around a protruding element and lock the blade using tension from the arch, a screw to screw in the blade on a flat surface and lock the blade, or various other alternatives not yet considered that will securely hold the blade so there is no movement when in use. Other various alternatives that can be used for fastening consists of: 1) plastic clamshell closure fastening mechanism with push to open or pull to open 2) watch like click to close and push to open fastening mechanism 3) ratchet like fastening mechanism 4) magnet based fastening mechanism 5) spring based fastening mechanism and 6) a latch fastening mechanism that can be made of plastic, metal or other suitable materials.

However, in each alternative there will always be the use of a single razor blade exposed to the users skin at a preset fixed angle, said fixed angle being between approximately 5 degrees and 35 degrees. In another embodiment, in each alternative the fixed angle is between approximately 15 degrees and 32 degrees. In another embodiment, in each alternative the fixed angle is between approximately 23 degrees and 27 degrees. In another embodiment, in each alternative the fixed angle is between approximately 22 degrees and 30 degrees. Additionally, the distance in the longitudinal gap 122 between the bottom wall portions is between 0.1 and 5 millimeters wide. In another embodiment, in each alternative the gap between the bottom wall portions is between 0.2 and 2.5 millimeters wide. In another embodiment, in each alternative the gap between the bottom wall portions is between 0.25 and 1.75 millimeters wide.

In another aspect, the present disclosure provides a method of making a shaving device. The method includes forming a retaining head having a slot defined in a contacting surface; providing a blade holding saddle that has a blade resting surface shaped to receive a shaving blade and that opens to the slot to present a cutting edge of the shaving blade, the blade holding saddle being distally angled at a shaving angle to the contacting surface and obliquely angled away from the handle; proximally attaching a handle to the retaining head; attaching a blade door to the retaining head to define a blade cavity and having blade gripping surface that corresponds to the blade resting surface of the blade holding saddle; and providing a locking mechanism to engageably hold the blade door in a closed position that tensions the shaving blade between the blade resting surface and the blade gripping surface.

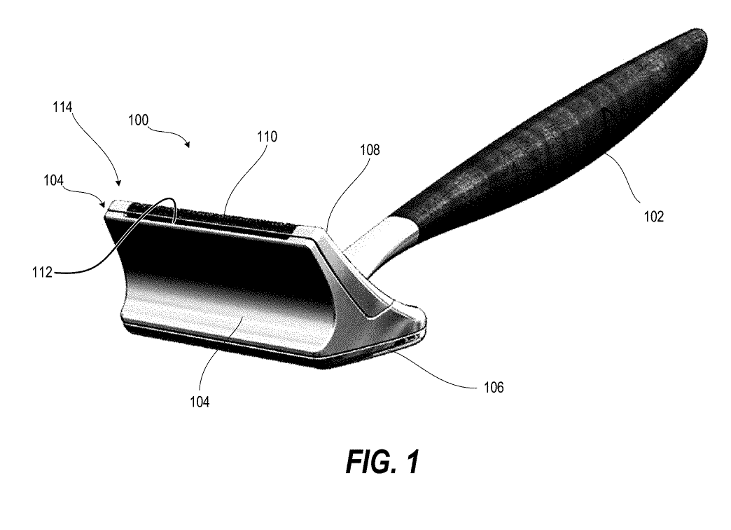

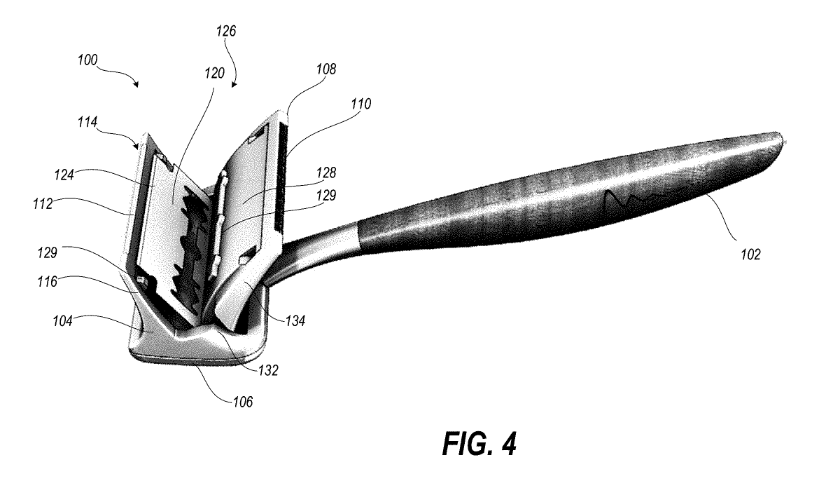

Turning to the drawings, FIGS. 1-6 depict an example shaving razor 100, according to one or more embodiments. With initial reference to FIG. 1, the shaving razor 100 has a handle 102 that attached at a proximal end of a plane body 104. In one embodiment, the handle 102 is attached at an acute angle to the contacting surface 106 of the plane body 104, although the handle 102 may be straight attached. A blade door 108 is depicted in a closed position to the plane body 104. A knurled top edge 110 of the blade door 108 and an optional pry gap 112 adjacently presented a top surface of the plane body 104 present an opportunity for manually prying open the blade door 108. In an exemplary aspect, the contacting surface 106 is a separable component that together with the blade door 108 and plane body 104 forms a retaining head 114. In the illustrative implementation, the contact surface is planar; however, other embodiments can have a curved surface. In one embodiment, the blade door 108 is separable from the retaining head 114.

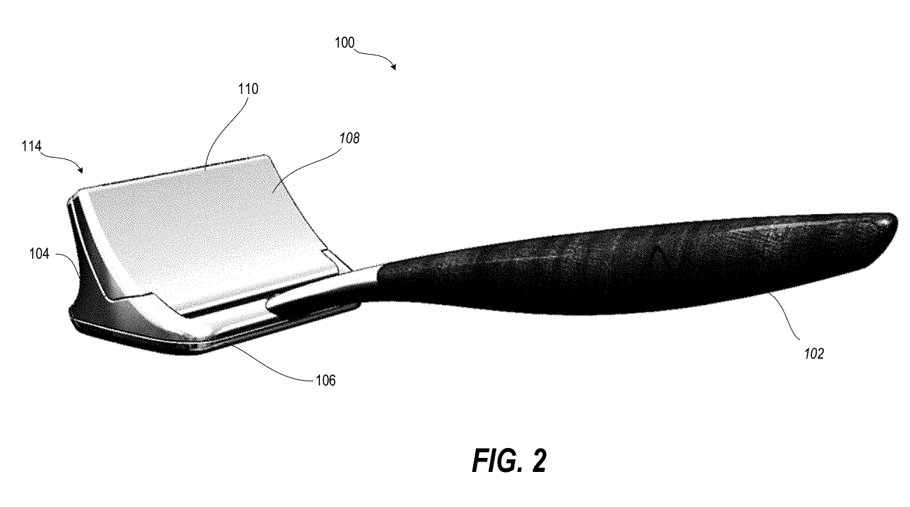

FIG. 2 illustrates that the blade door 108 is pivotally attached to the retaining head 104.

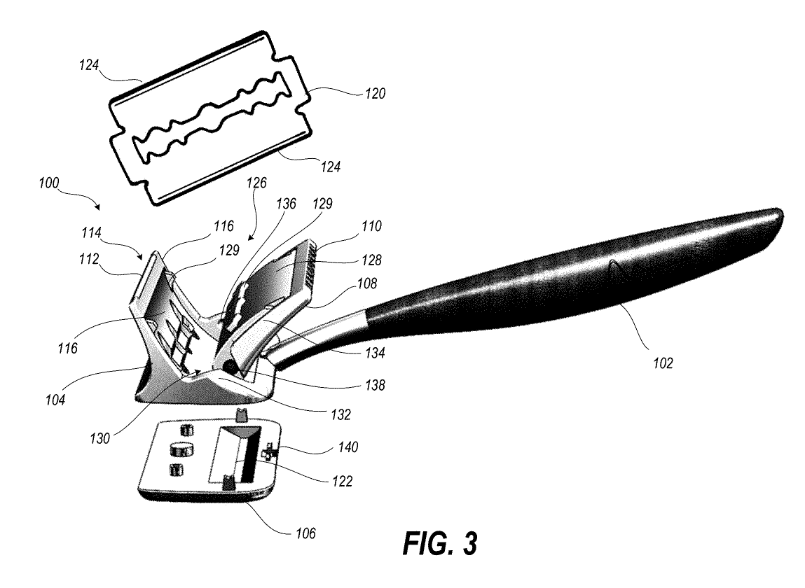

FIGS. 3-6 illustrate that the retaining head 104 includes a blade holding saddle 116 having a blade resting surface 118 shaped to receive a replaceable shaving blade 120 and that opens to a slot 122 in the contacting surface 106 to present a cutting edge 124 of the replaceable shaving blade 120. The blade holding saddle 116 is distally angled at a shaving angle to the contacting surface 106 and obliquely angled away from the handle 102. The shaving angle may be fixed, may be selectable at the original equipment manufacturer (OEM), or may be user selectable. The blade door 108 is pivotally attached to the blade holding saddle 116 of the retaining head 104 to define a blade cavity 126 and has blade-gripping surface 128 that corresponds to the blade resting surface 118 of the blade holding saddle 116. In one embodiment, the blade resting surface 118 is concave and the blade gripping surface 128 is correspondingly convex. Blade positioning features 129 in the blade resting surface 118 and blade gripping surface 128 ensure that the cutting edge 124 of the replaceable shaving blade 120 is accurately and securely positioned.

A locking mechanism 130 is provided to engageably hold the blade door 108 in a closed position that clamps the replaceable shaving blade 120 in tension (FIGS. 1-2 and 5). In one embodiment, the locking mechanism 130 is provided by the blade holding saddle 116 having a pair of lateral overlapping portions 132 aligned with at least a proximal, pivoting portion of lateral edges 134 of the blade door 108. The locking mechanism further includes a detent 136 formed in each of the pair of lateral overlapping portions 132 and a pair of spring-loaded rounded pins 138 slideably received in the lateral edges 134 of the blade door 108 and biased to extend outwardly into releasable engagement with a corresponding detent 136.

With particular reference to FIG. 3, the slot 122 can be a user-adjustable longitudinal opening of 1 mm to 5 mm wherein a longitudinal opening adjusting mechanism can manually set the longitudinal opening of the slot 122. In a particular aspect, the slot is a user adjustable longitudinal opening of 0.1 mm to 3.5 mm. In another embodiment, in each alternative the user adjustable longitudinal opening is adjustable between 0.2 and 2.5 millimeters wide. In another embodiment, in each alternative the user adjustable longitudinal opening is adjustable between 0.25 and 1.75 millimeters wide. With particular reference to FIG. 3, the slot 122 can be a longitudinal opening of 1 mm to 5 mm. In a particular aspect, more than one removable contacting surface 106 can be available, each presenting a selected slot characteristic to change the width of the longitudinal opening or a depth of the exposed cutting edge from the longitudinal opening.

In one aspect, the cutting edge 124 is presented at a fixed angle to a beard presented to the contacting surface 106 to slice rather than chop hair follicles. A proximal portion 140 of the contacting surface 106 to the slot 122 serves as a safety bar. For example, the angle can be 5° to 35°. In another embodiment, in each alternative the angle is between approximately 15° and 32°. In another embodiment, in each alternative the angle is between approximately 23° and 27°. Alternatively, the blade holding saddle 116 can be moveably coupled to the rest of the retaining head 104. An angle adjusting mechanism can manually set the acute angle of the cutting edge 124.

In one aspect, the cutting edge 124 is presented at a moveable, user-adjustable angle to a beard presented to the contacting surface 106 to slice rather than chop hair follicles. A proximal portion 140 of the contacting surface 106 to the slot 122 serves as a safety bar. For example, the angle can be 5° to 35°. In another embodiment, in each alternative the angle is between approximately 15° and 32°. In another embodiment, in each alternative the angle is between approximately 23° and 27°. An angle adjusting mechanism can manually set the angle of the cutting edge 124.

In another aspect, the cutting edge 124 is presented at an offset angle to the contacting surface 106 wherein cutting edge 124 is offset at an angle independent of the shaving angle such that the right or left edge trails while presented to the contacting surface 106. For example, the offset angle can be 5° to 45°. In another embodiment, in each alternative the offset angle is between approximately 10° and 35°. In another embodiment, in each alternative the offset angle is between approximately 15° and 30°. In another embodiment, in each alternative the angle is between approximately 23° and 27°. In one embodiment, an offset angle adjusting mechanism can manually set the offset angle of the cutting edge 124.

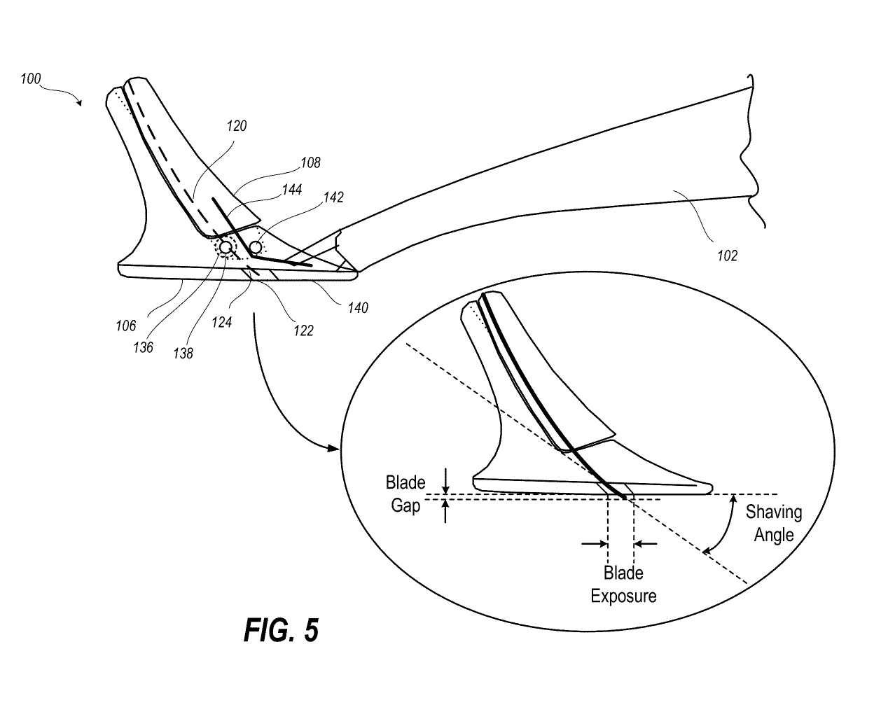

FIG. 5 illustrates the shaving device 100 with the blade door 108 closed, putting the enclosed replaceable shaving blade 120 in tension. The locking mechanism 130 is locked, with the spring-loaded rounded plunger 138 engaged into the detent 136. The blade door 108 is pivotally attached at an axle 142 to the lateral overlapping portions 132 retaining head 104. The locking mechanism 130 can be assisted with a leaf spring 144, shown in its unactuated position. In one or more embodiments, the cutting edge 124 is presented with a blade exposure to the contacting surface 106 of −0.001″ to 0.004″. In one or more exemplary embodiments, the cutting edge 124 is presented with a blade exposure to the contacting surface 106 of 0.000″ to 0.002″. In one or more embodiments, the cutting edge 124 is presented with a blade gap relating to the distance with nothing in between the blade edge and a corresponding contacting surface 106 of 0.2 mm to 0.8 mm. In one or more exemplary embodiments, the cutting edge 124 is presented with a blade gap in the contacting surface 106 of 0.4 mm to 0.8 mm. In one or more exemplary embodiments, the cutting edge 124 is presented with a blade gap in the contacting surface 106 of 0.6 mm to 0.8 mm.

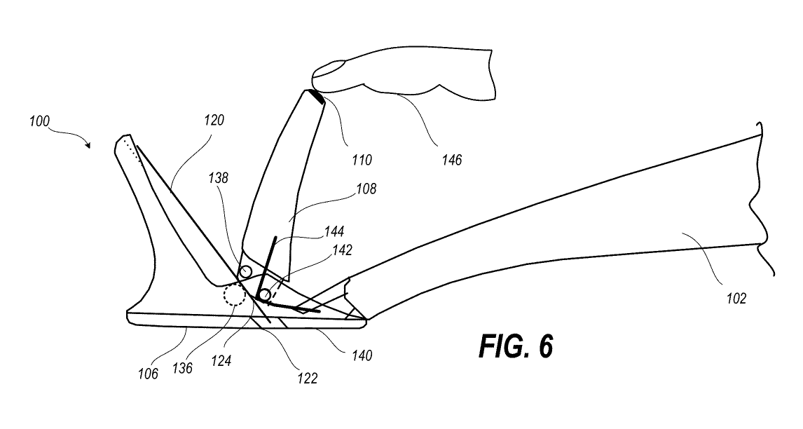

FIG. 6 illustrates a user 146 positioned the knurled top edge 110 of the blade door 108 to release the spring-loaded rounded plunger 138 from the detent 136 and to release the replaceable shaving blade 120 for turning over or for replacement. The leaf spring 144 is shown in its actuated position, asserting an increased closing force.

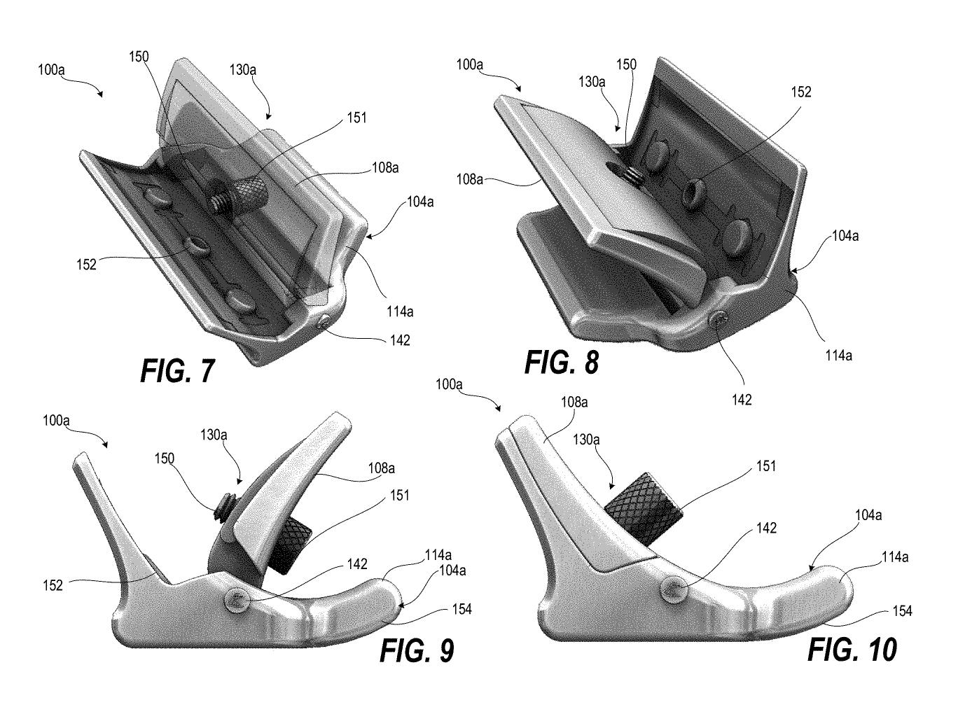

FIGS. 7-10 depict an alternative retaining head 114a for a shaving razor 100a. A locking mechanism 130a is formed from a screw 150 rotatably retained in a blade door 108a and a knob 151 for manually engaging an internally threaded feature 152 on a blade resting surface 118a of a blade holding saddle 116a. A contacting surface 106a includes a curved surface 154 for transitioning between portions of the user's skin. The axle 142 is exposed for easier assembly and repair.

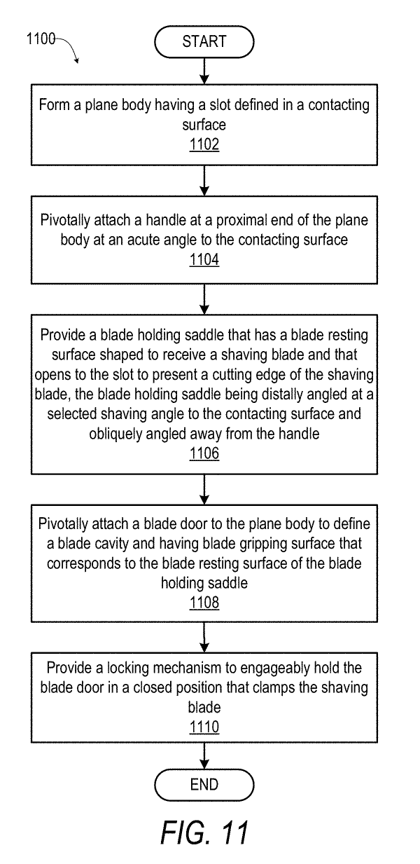

FIG. 11 illustrates a flow diagram of a method 1100 of making a shaving razor, according to one or more embodiments. The method 1100 includes forming a retaining head having a slot defined in a contacting surface (block 1102). The method 1100 includes pivotally attaching a handle at a proximal end of the retaining head at an acute angle to the contacting surface (block 1104). The method 1100 includes providing a blade holding saddle that has a blade resting surface shaped to receive a shaving blade and that opens to the slot to present a cutting edge of the shaving blade, the blade holding saddle being distally angled at a shaving angle to the contacting surface and obliquely angled away from the handle (block 1106). The method 1100 includes pivotally attaching a blade door to the retaining head to define a blade cavity and having blade gripping surface that corresponds to the blade resting surface of the blade holding saddle (block 1108). The method 1100 includes providing a locking mechanism to engageably hold the blade door in a closed position that clamps the shaving blade (block 1110).

In one embodiment, the method 1100 further includes presenting the cutting edge at an acute angle to a beard presented to the contacting surface to slice rather than chop hair follicles. A proximal portion of the contacting surface to the slot serves as a safety bar. For example, can be presented at the acute angle of 5° to 35° to the beard. In another embodiment, in each alternative the angle is between approximately 15° and 32°. In another embodiment, in each alternative the angle is between approximately 22° and 30°. In another embodiment, in each alternative the angle is between approximately 23° and 27°. In an exemplary aspect, the blade holding saddle can be moveably coupled to the retaining head. The method 1100 further includes providing an angle adjusting mechanism to manually set the acute angle of the cutting edge.

In one embodiment, the slot is a longitudinal opening of 0.1 mm to 5 mm. In another embodiment, in each alternative the gap is between 0.2 and 2.5 millimeters wide. In another embodiment, in each alternative the gap is between 0.25 and 1.5 millimeters wide. In an exemplary aspect, the retaining head comprises one of a plurality of removable contacting surfaces each presenting a selected slot characteristic. The method 1100 further comprising providing a second one of the plurality of removable contacting surfaces that is user selectable.

In one embodiment, the locking mechanism comprises a screw retained in the blade door aligned to pass through the shaving blade and to manually engage the blade holding saddle.

In one embodiment, the blade door has a pair of lateral overlapping portions aligned with the blade holding saddle in the closed position, the locking mechanism comprising: a detent formed in each of the pair of lateral overlapping portions; and a pair of spring-loaded pins biased to extend outwardly into releasable engagement with a corresponding detent.

In one aspect, the blade resting surface is concave and the blade gripping surface is correspondingly convex.

In one embodiment, the contact surface comprises a planar surface. Alternatively, the contact surface is a convex surface.

In the above described flow chart of FIG. 11, one or more of the methods may be embodied in an automated manufacturing system that performs a series of functional processes. In some implementations, certain steps of the methods are combined, performed simultaneously or in a different order, or perhaps omitted, without deviating from the scope of the disclosure. Thus, while the method blocks are described and illustrated in a particular sequence, use of a specific sequence of functional processes represented by the blocks is not meant to imply any limitations on the disclosure. Changes may be made with regards to the sequence of processes without departing from the scope of the present disclosure. Use of a particular sequence is therefore, not to be taken in a limiting sense, and the scope of the present disclosure is defined only by the appended claims.

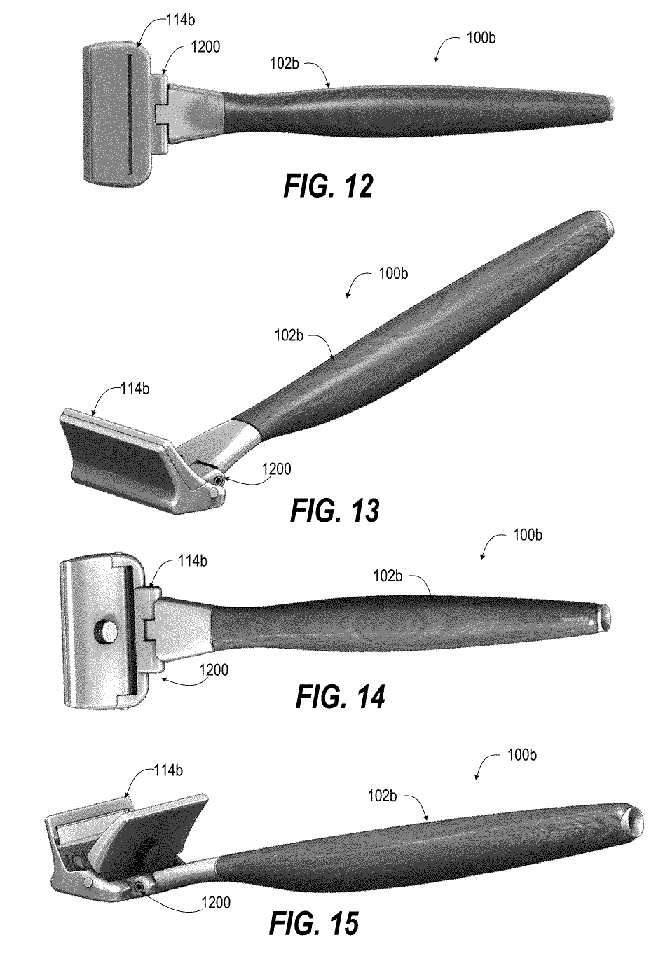

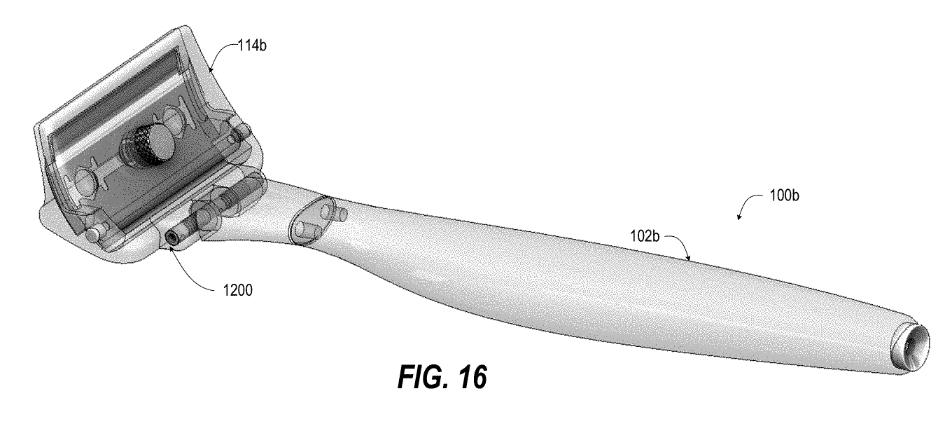

FIGS. 12-16 depict a further alternative shaving razor 100b wherein a handle 102b has a pivotal attachment 1200 to a retaining head 114b.

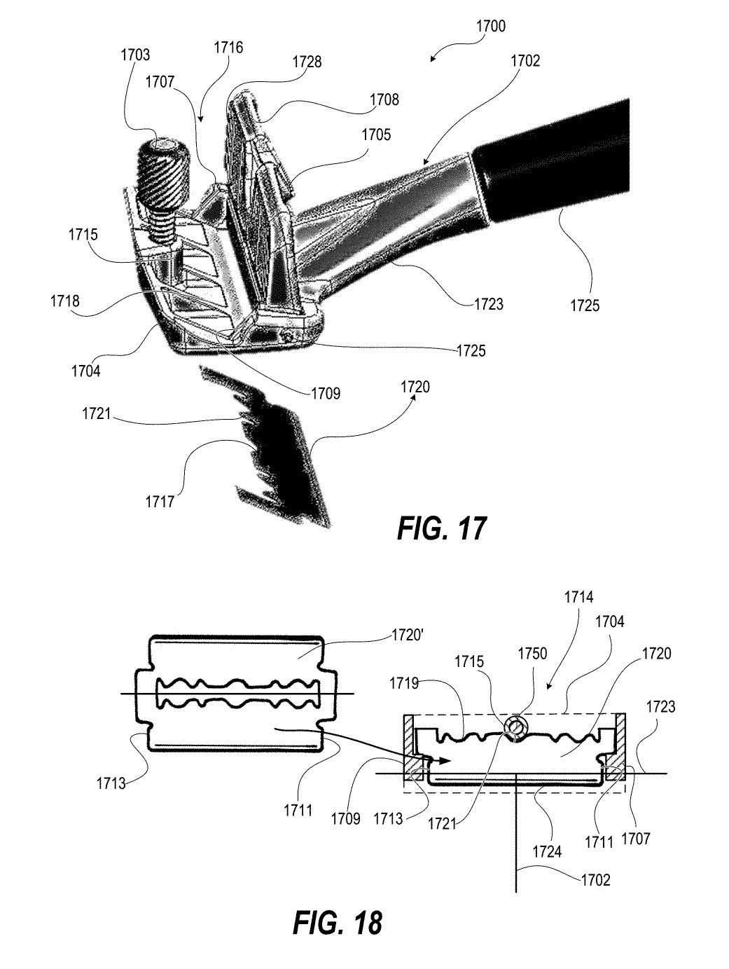

FIGS. 17-23 depict an exemplary shaving razor 1700 having a base-mounted screw 1750 with a hand-tightened knurled head 1703 that clamps to a half-collar recess 1705 when a pivoting blade door 1708 is closed against a plane body 1704 to form a retaining head 1714 to hold a shaving blade, which in an exemplary embodiment is a half safety blade 1720. With particular reference to FIGS. 17-18, right and left side guards 1707, 1709 on each side of a blade supporting saddle 1716 receive right and left indented sides 1711, 1713 on each side of a cutting edge 1724 of the half safety blade 1720 rather than the cutting edge 1724 like generally-known safety razors. A screw mount 1715 centrally formed in the plane body 1704 cooperates with the right and left side guards 1707, 1709 to locate the half safety blade 1720 by abutting a central recess 1717 on a non-cutting side 1719. The plane body 1704 provides a blade resting surface 1718 of the blade supporting saddle 1716 and the pivoting blade door 1708 provides a blade gripping surface 1728 of the blade supporting saddle 1716 (FIG. 17). The half safety blade 1720 can be economically purchased by a consumer as a whole safety blade 1720′ (FIG. 18) that is folded lengthwise in half. Alternatively, half safety blades 1720 can be purchased. The shaving razor 1700 provides improved shaving performance over generally-known safety razors while taking advantage of this economy. The blade supporting saddle 1716 provides a flow path 1719 from the cutting edge 1724 to the non-cutting side 1721 of the half safety blade 1720 for enabling continuous shaving without having to unclog the shaving razor 1700. In an exemplary embodiment, the blade door 1708 that clamps the half safety blade 1720 is specifically shaped with a depressed region to allow for unhindered shaving cream and cut hair to flow and not to clog. The depressed region allows the wall of the blade door 1708 to be as thin and smooth as possible while pressing against the half safety blade 1720 in order for this cream not to get stuck on anything and allow for clogging.

In one or more embodiments, the cutting edge 1724 is presented with a blade exposure to the contacting surface 1706 of −0.001″ to 0.004″. In one or more exemplary embodiments, the cutting edge 1724 is presented with a blade exposure in the contacting surface 1706 of 0.000″ to 0.002″. In one or more embodiments, the cutting edge 1724 is presented with a blade gap relating to the distance with nothing in between the blade edge and a corresponding contacting surface 1706 of 0.2 mm to 0.8 mm. In one or more exemplary embodiments, the cutting edge 1724 is presented with a blade gap in the contacting surface 1706 of 0.6 mm to 0.8 mm. In one or more exemplary embodiments, the cutting edge 1724 is presented with a blade gap in the contacting surface 1706 of 0.6 mm to 0.8 mm.

An adjustable pivoting neck 1723 of a handle 1702 shares a pivotal mounting axis 1725 with the blade door 1708 to reduce parts and assembly steps (FIG. 17). A gripping portion 1727 of the handle 1702 is threadably received by the adjustable pivoting neck 1723.

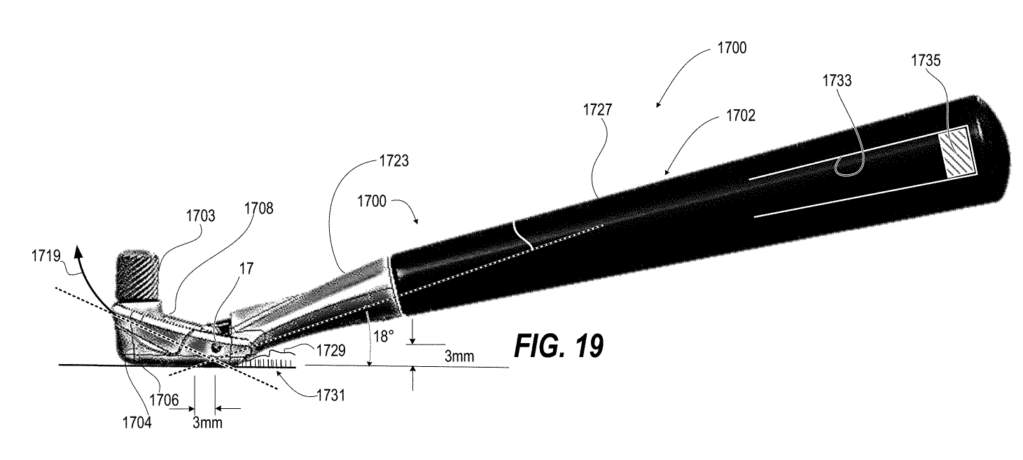

FIG. 19 illustrates that the single pivoting axis 1725 can provide an 18° pivotal attachment to the handle 1702 with respect to a contacting surface 1706 of the plane body 1704. The handle 1702 is blocked from decreasing the angle but can be resiliently pivoted to a greater angle. In an exemplary embodiment, the single pivoting axis 1725 is from 0 mm to 3 mm proximal to and 0 mm to 3 mm above the cutting edge 1724 (FIG. 17). Shaving crème 1729 and hair 1731 can proceed through the flow path 1719 in the retaining head 1714. Removal of the gripping portion 1727 of the handle 1702 from the adjustable pivoting neck 1723 can expose a cylindrical cavity 1733 that receives a magnet 1735 for picking up a shaving blade.

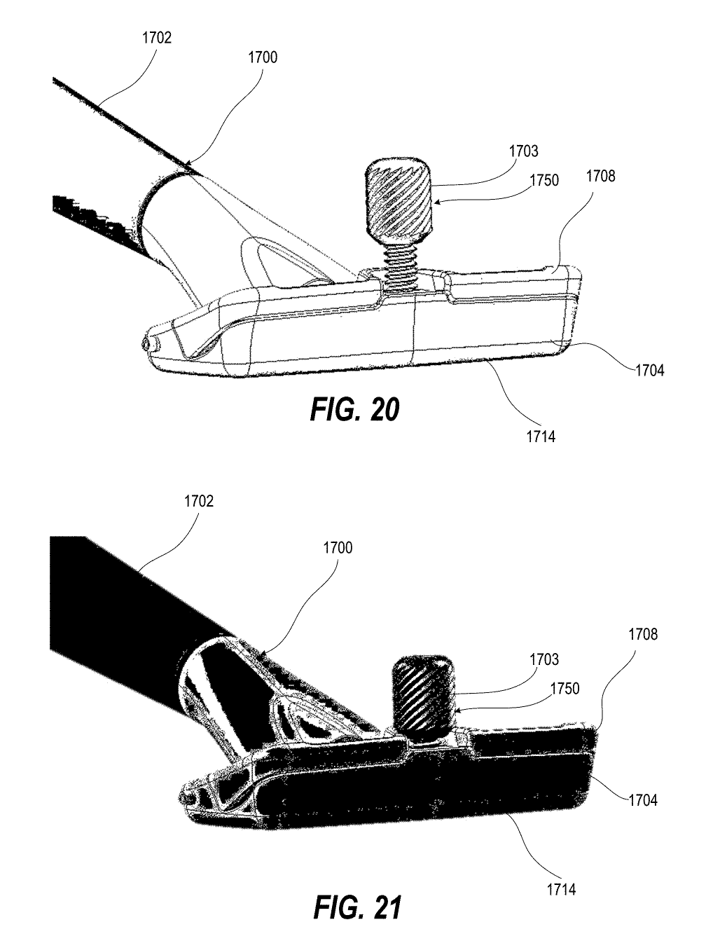

FIG. 17 illustrates the base-mounted screw 1750 in an extended position with the hand-tightened knurled head 1703 in an unobstructing location with respect to pivoting of the blade door 1708, which is open. FIG. 20 illustrates the base-mounted screw 1750 in the same extended position with the hand-tightened knurled head 1703 in an unobstructing location with respect to pivoting of the blade door 1708, which is closed. FIG. 21 illustrates the base-mounted screw 1750 in an inserted position with the hand-tightened knurled head 1703 in an obstructing location with respect to pivoting of the blade door 1708, which is closed and locked.

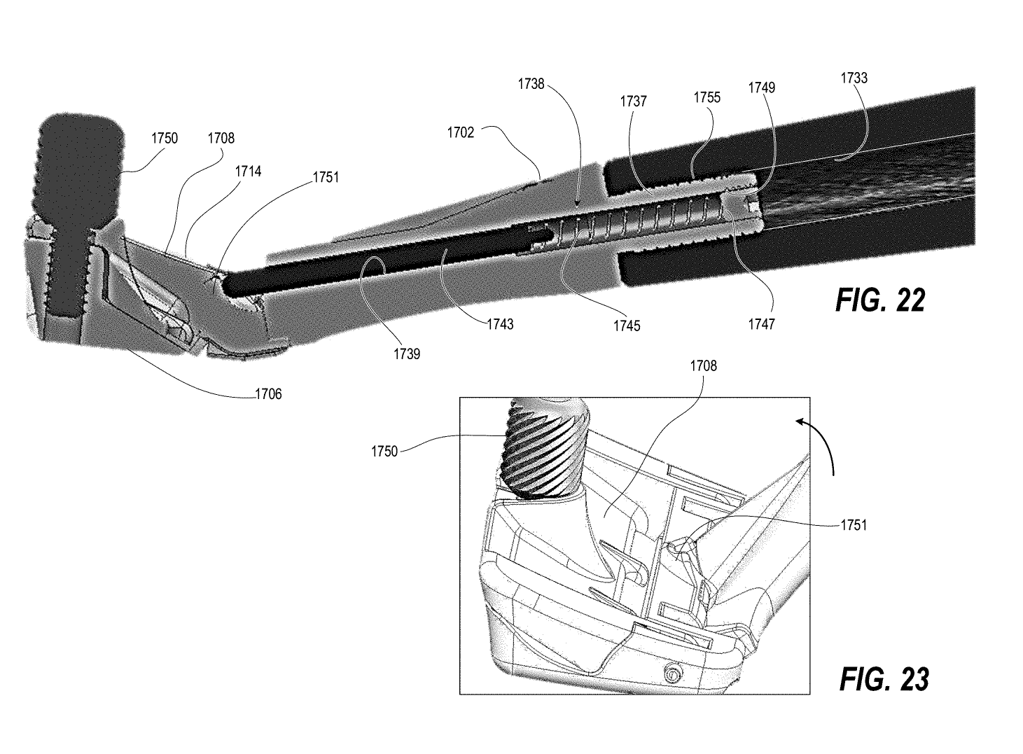

FIG. 22 illustrates a threaded outer diameter 1755 of an extension 1737 of the adjustable pivoting neck 1723 that is received in the cylindrical cavity 1733 that the gripping portion 1727 of the handle 1702. A spring mechanism 1738 biases the handle 1702 to the 18° degree position with regard to the retaining head 1714. In particular, a bore 1739 passes through the extension 1737 and a distal portion 1741 of the adjustable pivoting neck 1723. A plunger 1743 is received for movement in the bore 1739 and contacts the blade door 1708. A compression spring 1745 proximally is received in the bore 1739 to push the plunger 1743 against the blade door 1708. An adjustment screw 1747, such as a set screw or thumb screw, is received within an internally threaded end 1749 of the bore 1739. The adjustment screw 1747 can be adjusted to provide a desired amount of resilient force for biasing the blade door 1708 shut and to bias the retaining head 1714 to the ready position of 18°. This biasing force can assist in maintaining the contacting surface 1706 in contact with the skin during shaving. Removal of the adjustment screw 1747 enables replacement or cleaning of the spring mechanism 1738. FIGS. 22-23 illustrate a plunger receptacle 1751 formed in the plane body 1704 for receiving the plunger 1743 (FIG. 22).

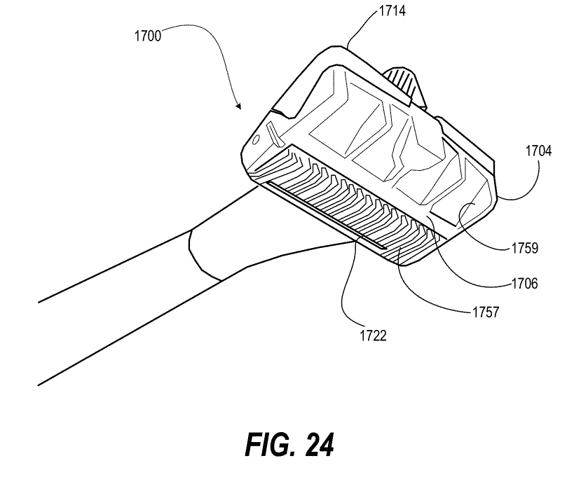

FIG. 24 illustrates the shaving device 1700 having the plane body 1704 that includes longitudinal ribs 1757 distal to the slot 1722 defined in the contacting surface 1706 that stretch the skin to obtain an effective cut. Recessed apertures 1759 formed in a distal portion of the contacting surface 1706 provide a flow path for shaving crème and hair stubble to exit from the retaining head 1714.

In one or more embodiment, the metal portions of the shaving razor 1700 can be formed from metal injection molding. The base-mounted screw 1750 can be captive in the plane body 1704. Alternatively, the base-mounted screw 1750 can be used that is not captive. In one or more embodiments, a handle can be formed from a single injection molded portion having a bore defined therein.

All publications, patents and patent applications cited herein, whether supra or infra, are hereby incorporated by reference in their entirety to the same extent as if each individual publication, patent or patent application was specifically and individually indicated as incorporated by reference. It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A shaving device, comprising:
a retaining head comprising:
a plane body having a slot defined in a contacting surface and having a blade resting surface shaped to receive a shaving blade and that opens to the slot to present a cutting edge of the shaving blade;
a blade door pivotally attached to the plane body and having blade gripping surface that corresponds to the blade resting surface; and
a locking mechanism to engageably hold the blade door in a closed position that tensions the shaving blade between the blade resting surface and the blade gripping surface; and
a handle that is proximally and pivotally attached to a proximal side of the retaining head to move within a pivotal range to the plane body, wherein the blade resting surface of the plane body being distally angled at a shaving angle to the contacting surface and obliquely angled away from the handle.

2. The shaving device of claim 1, wherein the locking mechanism is a screw received in the plane body and having a widened screw head that is positionable between an extended position that enables the blade door to be opened and an inserted position that holds the blade door closed.

3. The shaving device of claim 2, wherein the screw is captive in one of the plane body and the blade door.

4. The shaving device of claim 1, further comprising a single pivotal axis about which the blade door and the handle pivot to the plane body.

5. The shaving device of claim 1, wherein the handle contains a magnet for picking up shaving blades.

6. The shaving device of claim 1, wherein the handle is pivotally attached to move within a pivotal range to the plane body, the shaving device further comprising a spring mechanism biasing the plane body toward a minimum pivot angle.

7. The shaving device of claim 6, wherein the spring mechanism comprises a plunger receptacle formed in the plane body, a bore formed in the handle, a plunger received for movement in the bore, and a compression spring proximally received in the bore to resiliently urge the plunger into contact with the plunger receptacle.

8. The shaving device of claim 7, where the handle comprises a proximal portion containing the bore and a removable gripping portion having a cylindrical cavity that threadingly engages a threaded outer diameter of an extension of the proximal portion.

9. The shaving device of claim 8, wherein the bore proximally opens through the extension of the proximal portion, the spring mechanism further comprising an adjustable screw for retaining the compression spring at a selected compression value for adjusting the resilient force on the blade door and retaining head.

10. The shaving device of claim 1, wherein the shaving blade comprises a half safety blade having one cutting edge.

11. The shaving device of claim 1, wherein the shaving blade comprises a safety blade having two cutting edges.

12. The shaving device of claim 1, wherein the safety blade forms a cutting angle between 15° to 32° to the contacting surface.

13. The shaving device of claim 1, wherein the contacting surface of the plane body comprises a flat contacting surface with a slot comprising a rectangular proximal opening defining a blade gap of the cutting edge of the shaving blade for the cutting edge to extend out for a blade exposure.

14. The shaving device of claim 13, wherein the blade exposure comprises a distance out of the contacting surface of −0.001″ to 0.004″.

15. The shaving device of claim 14, wherein the distance of the blade gap is between 0.04 mm to 0.08 mm.

16. The shaving device of claim 15, further comprising a pivotal axis about which the handle pivotally attached to the plane body and which is 0.5 mm to 4 mm proximal to the blade exposure and 0.5 to 4 mm spaced away from contacting surface.

17. The shaving device of claim 1, wherein the retaining head comprises a flow path from a cutting edge to an opposite, non-cutting edge of the shaving blade and distally out of the retaining head.

18. The shaving device of claim 1, wherein:
the shaving blade comprises indents on each side of the cutting edge;
the plane resting surface comprising guards that are received in the indents to locate the shaving blade; and
the plane body comprises longitudinal ribs distal to the slot defined in the contacting surface.

19. A shaving device, comprising:
a retaining head comprising:
a plane body having a slot defined in a contacting surface and having a blade resting surface shaped to receive a shaving blade and that opens to the slot to present a cutting edge of the shaving blade;
a spring mechanism biasing the plane body toward a minimum pivot angle; and
a handle that is proximally and pivotally attached to a proximal side of the retaining head to move within a pivotal range to the plane body, wherein the blade resting surface of the plane body being distally angled at a shaving angle to the contacting surface and obliquely angled away from the handle.

20. The shaving device of claim 19, wherein the spring mechanism comprises a plunger receptacle formed in the plane body, a bore formed in the handle, a plunger received for movement in the bore, and a compression spring proximally received in the bore to resiliently urge the plunger into contact with the plunger receptacle.
